(19) United States
(12) Patent Application Publication
(10) Pub. No.: US 2011/0298627 A1
(43) Pub. Date: Dec. 8, 2011

(54) Flex-Mount Sensor

(75) Inventor: Wade C. Wheeler, Hillsboro, OR (US)

(73) Assignee: MTI, INC., Hillsboro, OR (US)

(21) Appl. No.: 12/792,277

(22) Filed: Jun. 2, 2010

(51) Int. Cl. G08B 21/00

(52) U.S. Cl. 340/665

(57) ABSTRACT

A flex-mount sensor has an electrical contact portion that is at least partly surrounded by a lower housing. The lower housing has a central portion. A flexible adhesive strip has an opening that is placed over the upper portion. An upper housing serves as a cap that sandwiches the flexible material between the upper and lower housings. Lateral portions of the flexible material are used to join the sensor to an article for theft-deterrent purposes.

### TECHNICAL FIELD

The invention described here relates to what is known in the field as “security sensors.” In other words, the invention is an anti-theft sensor that is attached to an electronic hand-held device offered for sale in a retail location.

### SUMMARY OF THE INVENTION

The invention is a flex-mount security sensor. The security sensor includes a feature that through either the opening or closing of an electrical path, the sensor can sense when it has been removed from the article it is attached to. In some cases the security sensor includes a portion with a switch or spring-loaded mechanical plunger that presses against an article (e.g., cell-phone, camcorder, PDA) when the security sensor is installed on the article. In other cases, a flexible circuit can be embedded directly into the fabric of the flexible mount. This flexible circuit is fragile enough that the act of peeling away the fabric will cause the traces in the circuit to break, thus activating an alarm. The purpose of the security sensor is to provide anti-theft protection for articles offered for sale to consumers in retail locations.

The security sensor has a housing that at least partially surrounds the electrical interface. A flexible material extends laterally away from the housing. The flexible material is characterized in that it is sufficiently flexible so as to conform to an outer surface region of the article (i.e., a curved surface, etc.). An adhesive material, or the like, is located on an underside surface of the flexible material and joins the material to the article, thus attaching the security sensor to the outer surface of the article, with the mechanical plunger or flex circuit being pressed against the article.

Security sensors are generally disclosed in U.S. Pat. No. 5,861,807 to Leyden. An advantage to the present invention is that it provides an improved way for attaching security sensors to articles for sale. In the past, security sensors used an adhesive pad directly under the switch or plunger portion with a limited foot-print area for adhering the security sensor to the article. By adding one or more sections of flexible material that extends laterally away from the housing, it is possible to increase the foot-print of the surface contact area a significant amount.

In some cases, the flexible material may be extended a sufficient distance so that it fully surrounds the surface perimeter of the article, thus making it very difficult to remove. This is desirable because the retailer wants the security sensor to be triggered only when a theft event occurs. It is not desirable to have situations where a security sensor is inadvertently knocked off due to normal product handling, because it triggers false theft alarms. The surrounding of the surface perimeter of the article has been accomplished with mechanical brackets in the past, but these brackets are awkward, heavy and expensive. The use of them diminishes the shopping experience.

The invention as summarized above will become better understood upon review of the drawings and the text that follows.

### BRIEF DESCRIPTION OF THE DRAWINGS

In the drawings, like reference numerals and letters refer to like parts throughout the various views, and wherein:

FIG. 1 is an exploded view of a flex-mount security sensor constructed in accordance with a preferred embodiment of the invention;

FIG. 2 is a pictorial view of the flex-mount security sensor and shows the sensor installed on a pen-type device;

FIG. 3 is an alternative embodiment of the flex-mount security sensor illustrated in FIG. 1;

FIG. 4 is an enlarged view of the embodiments illustrated in FIG. 3;

FIG. 5 is a plan view of a flexible circuit embedded in the fabric of the flex-mount security sensor illustrated in FIGS. 3 and 4;

FIG. 6 is a view like FIG. 3, but shows the flex-mount security sensor exploded from a hand-held device;

FIG. 7 is a view like FIGS. 3 and 6, and shows the flex-mount security sensor connected to the hand-held;

FIG. 8 is a top plan view of a “secondary sensor cable” and shows the flex-mount security sensor on the end of the cable;

FIG. 9 is a view like FIG. 8, but illustrates an alternative example of a secondary sensor cable;

FIG. 10 is a cross-sectional view of the flex-mount security sensor;

FIG. 11 is a bottom plan view of the flex-mount security sensor shown in FIG. 10;

FIG. 12 is a front view of the flex-mount security sensor shown in FIGS. 10 and 11;

FIG. 13 is a side view of the flex-mount security sensor shown in FIGS. 10-12; and

FIG. 14 is a perspective view of the flex-mount security sensor shown in FIGS. 10-13.

### DETAILED DESCRIPTION

Referring now to the drawings, and first to FIG. 1, shown generally at 10 is an exploded view of a flex-mount sensor constructed in accordance with one preferred embodiment of the invention. The sensor 10 includes a conventional switch or mechanical plunger-type sensor 12, with reference numeral 14 indicating the mechanical plunger. The switch portion 12 is received within a lower housing 16 that is made from molded plastic or another suitable material.

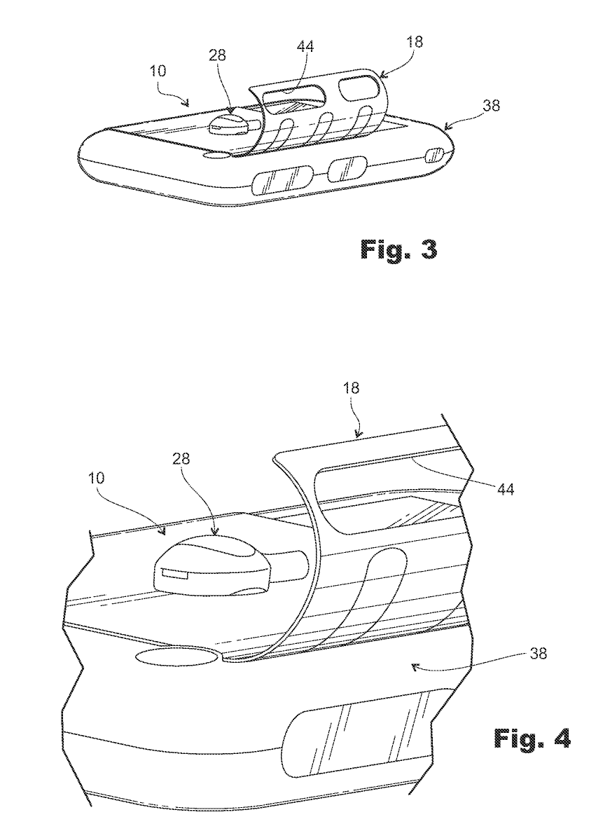

A flexible material 18 has a central opening 20 that fits over the upper portion 22 of lower housing 16. The flexible material 18 may be made from a metallic material. Regardless of specific material selection, however, it should be sufficiently flexible so as to conform to the curvature of any article to which the sensor is to be attached. Referring to FIG. 3, for example, in preferred form, the flexible material 18 will have lateral arms 24, 26 that extend laterally away from each side of the sensor 10, which is further described below.

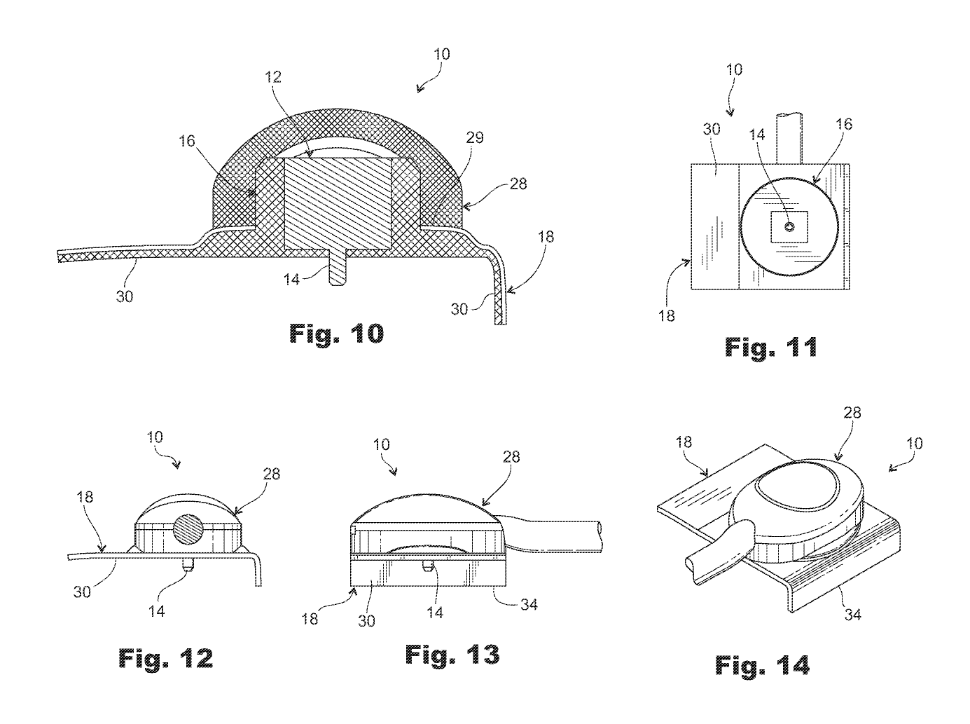

Referring again to FIG. 1, the flexible material 18 is captured and held in place on the lower housing 16 by an upper housing 28. The upper housing 28 functions as a cap for the entire flex-mount sensor assembly 10. As is best seen in FIG. 10, the upper housing 28 sandwiches the flexible material 18 between the upper and lower housing 28, 16 (see numeral 29). The mechanical plunger 14 will press against the article's surface when the sensor 10 is installed.

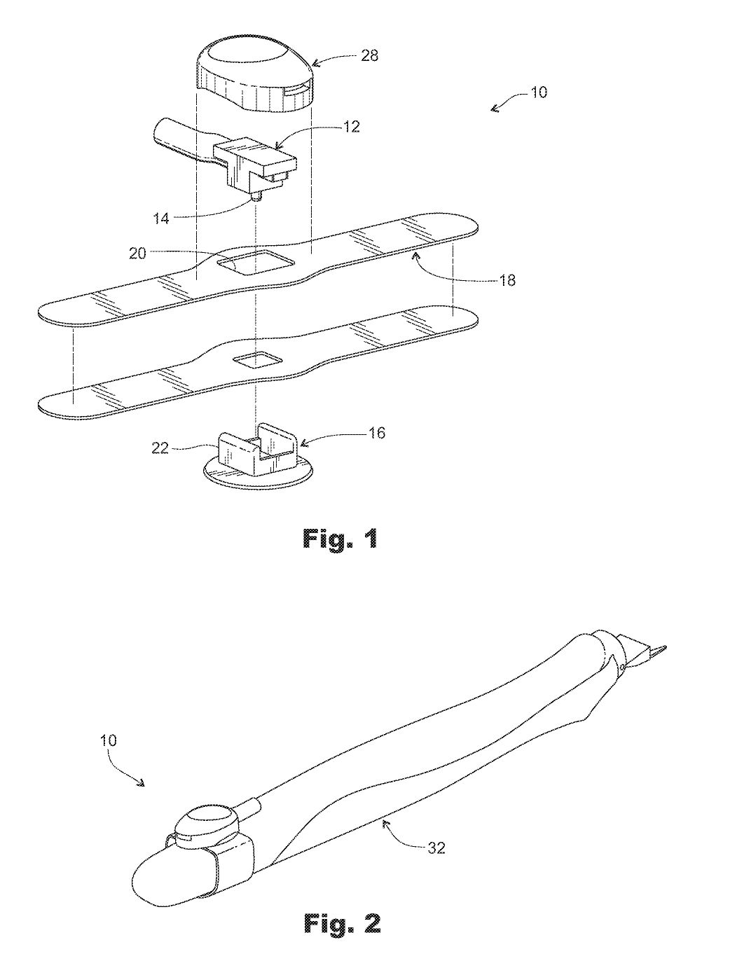

In preferred form, there will be an adhesive strip 30 that underlies the flexible material 18. The adhesive material 30 may be a VHB material, or the like, that allows the flexible material 18 to be wrapped around and adhered to the article, as generally illustrated in FIG. 2. FIG. 2 illustrates an example of a pen-type device that might be offered for sale on a display (the device or article is indicated generally at 32).

There may be alternatives to the adhesive material 30 described above. For example, for sensor mounts like the one illustrated in FIG. 2, it might be possible to use a Velcro-type material to join the arms 24, 26 (see FIGS. 3 and 4) together in surrounding relationship relative to the article 32. Either way, the laterally extending arms 24, 26 increase the surface area of the sensor-to-article connection, thus making it more difficult to remove the sensor 10 from the article 32.

It should be appreciated that, in the past, security sensors had a smaller adhesive area that more or less corresponded to the foot-print of the micro switch portion 12 of the device. With the smaller foot-print, in time, the security sensor tended to become detachable from the article. Accidental or inadvertent detachment creates an unwanted security alarm. Therefore, providing a better means of attaching the sensor to the article reduces the chances of inadvertently setting off an alarm.

FIGS. 11-14 show an alternative shape for the flexible material 18. It is to be appreciated that the articles offered for display by a retailer (e.g., electronic hand-helds like PDAs, cell-phones, etc.) will have a wide variety of housing shapes and configurations. The flexible material 18 illustrated in FIGS. 11-14 has more of a rectangular shape and is well suited to be mounted to a hand-held that has a body with a squared corner edge. In this embodiment, one side edge 34 can be bent around the corner, if desired.

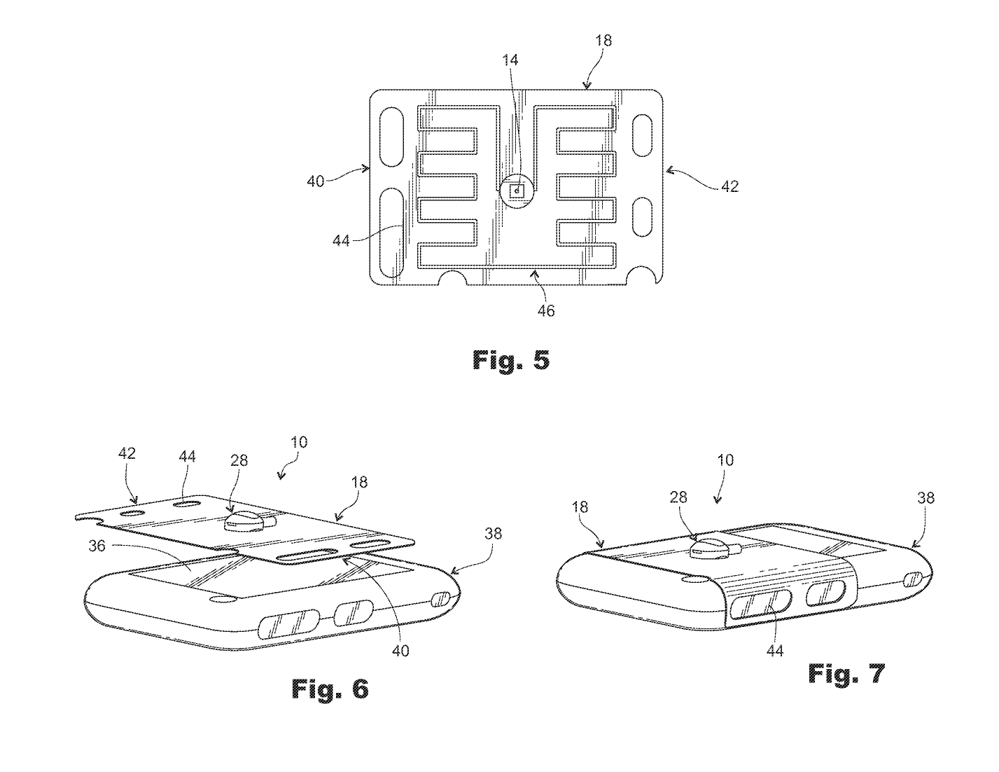

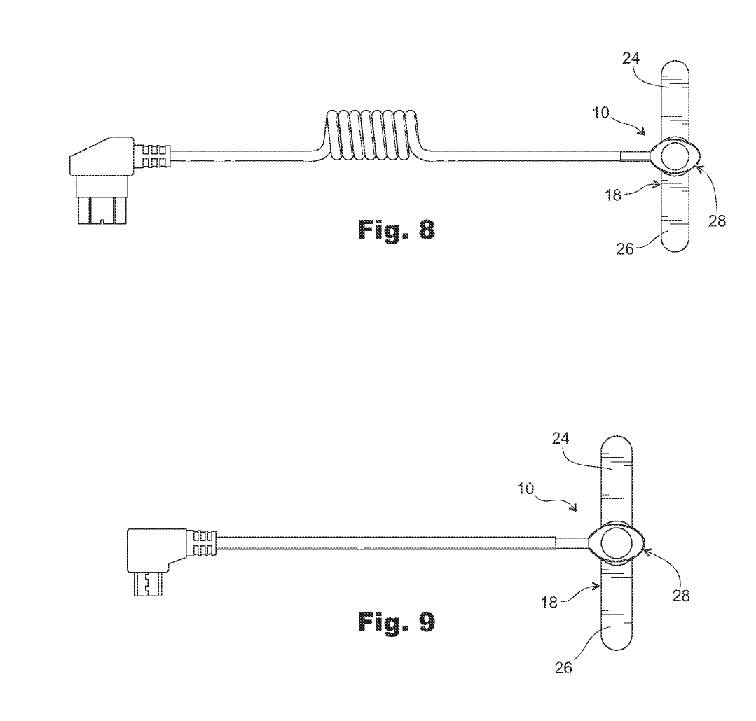

Another embodiment of the invention is illustrated in FIGS. 3-7. Directing attention first to FIG. 3, in this alternative embodiment, the flexible material 18 has an even larger footprint that covers an upper side portion 36 (see FIG. 6) of a hand-held 38. The flexible material 18 has opposite edge portions 40, 42 that overlap each side of the hand-held, as illustrated in FIG. 7. The flexible material 18 preferably has openings 44 (see FIG. 5) that provide access to various ports or buttons on the hand-held 38.

Conceptually, the embodiment illustrated in FIGS. 3-7 is similar to the embodiment illustrated in FIGS. 1-2 and 10-14. In the second case, however, the flexible material 18 carries a flexible circuit 46. The flexible circuit 46 is a general purpose flexible circuit that may bend as the flexible material 18 is installed in the hand-held 38. Flexible circuits would be familiar to a person skilled in the art and, as one would expect, flexible circuits may be made from a range of materials. One of the more common types of flexible material used today is Dupont's Kapton™.

The flexible circuit 46 provides a second type of alarm switch that is triggered if the circuit is broken. The advantage to the flexible circuit 46 is that it allows the security sensor 10 to be applied to products that have odd form factors or different kinds of shapes.

The invention as described above may be altered without departing from what is to be the spirit and scope of the invention. The scope of the patent right is to be limited only by the patent claim or claims that follow, the interpretation of which is to be made in accordance with the established doctrines of patent claim interpretation.

What is claimed is:

1. A flex-mount security sensor, comprising:
a portion with a switch that presses against an article when the security sensor is in an installed condition;
a housing that at least partially surrounds the switch portion;
a flexible material extending laterally away from said housing, said material being sufficiently flexible to conform to an outer surface of said article; and
an adhesive material located on an underside surface of said flexible material, for joining said security sensor to said article.

2. The flex-mount sensor of claim 1, wherein the flexible material includes a pair of lateral portions extending away from said housing in opposite directions.

3. The flex-mount sensor of claim 2, including a VHB material on the underside of said flexible material for adhering said security sensor to said article.

4. The flex-mount sensor of claim 2, wherein the flexible material includes openings for providing finger access to buttons, and ports on the article to be secured.

5. A flex-mount security sensor, comprising:
a portion with a switch that presses against an article when the security sensor is in an installed condition;
a lower housing that at least partially receives the switch portion;
a flexible material extending laterally away from said housing, said material being sufficiently flexible to conform to an outer surface of said article, and further, said flexible material having an opening that surrounds a portion of said lower housing;
an upper housing capping said lower housing and sandwiching at least a portion of said flexible material between said upper and lower housing; and
means for using said flexible material to join said secondary sensor to said article.

6. The flex-mount sensor of claim 5, wherein said means for using said flexible material to join said security sensor to said article is an adhesive material located on an under side surface of said flexible material.

7. A flex-mount security sensor, comprising:
a flexible material that is sufficiently flexible to conform to different surface shapes of an article;
means for attaching the flexible material to the article; and
a flexible circuit carried by the flexible material, with the flexible circuit being arranged to be broken when the flexible material is removed from the article.

8. The flex-mount security sensor of claim 7, wherein said attachment means is an adhesive material located on an underside of said flexible material.
